(19) United States
(12) Patent Application Publication
(10) Pub. No.: US 2011/0213687 A1
(43) Pub. Date: Sep. 1, 2011

(54) SYSTEMS AND METHODS FOR OR A USAGE MANAGER FOR CROSS-CLOUD APPLIANCES

(76) Inventors: James Michael Ferris, Cary, NC (US); Gerry Edward Riveros, Raleigh, NC (US)

(21) Appl. No.: 12/714,334

(22) Filed: Feb. 26, 2010

(51) Int. Cl. G06F 17/30; G06F 15/16; G06Q 30/00; G06Q 50/00

(52) U.S. Cl. 705/34; 707/802; 709/226; 707/E17.044

(57) ABSTRACT

Embodiments relate to systems and methods for a usage manager for cross-cloud appliances. A vendor, developer, or other user can generate one or more sets of computing appliances, comprising special-purpose pre-configured physical or virtual machines. The vendor can register an image of the one or more appliances to an image generation service, which can store that image along with the subscription model desired for that set of appliances. The image generation service can generate, test, and install a set of cloud-based images of the underlying appliances to a cloud environment including multiple, diverse clouds. The image generation service can adjust the cloud-based images as well as the subscription model to match the services and other resources of individual clouds, and ensure compatibility across multiple clouds. The image generation service can track usage data for billing or other management purposes.

### FIELD

The present teachings relate to systems and methods for a usage manager for cross-cloud appliances, and more particularly to platforms and techniques for hosting, generating, testing, and tracking the usage of a set of images of computing appliances generated and tailored to populate diverse cloud-based networks.

### BACKGROUND OF RELATED ART

The advent of cloud-based computing architectures has opened new possibilities for the rapid and scalable deployment of virtual Web stores, media outlets, and other online sites or services. In general, a cloud-based architecture deploys a set of hosted resources such as processors, operating systems, software and other components that can be combined or strung together to form virtual machines. A user or customer can request the instantiation of a virtual machine or set of machines from those resources from a central server or management system to perform intended tasks or applications. For example, a user may wish to set up and instantiate a virtual server from the cloud to create a storefront to market products or services on a temporary basis, for instance, to sell tickets to an upcoming sports or musical performance. The user can lease or subscribe to the set of resources needed to build and run the set of instantiated virtual machines on a comparatively short-term basis, such as hours or days, for their intended application.

A developer or other user can develop a set of computing appliances, which can be physical machines and/or virtual machines including dedicated application packages. Under cloud architectures in place today, if the user wishes to extend those appliances to one or more cloud-based networks, the user is required to individually build, test, and instantiate the necessary images and cloud resources for those appliances one a per-cloud basis, to ensure compatibility with the operating requirements of various cloud hosts. The developer or other user will likewise be forced to individually specify and track the subscription models that will apply to each cloud host, to generate accurate usage, billing, and/or other data. It may be desirable to develop systems and techniques for generating images of appliances or other software or objects to populate multiple host clouds via a unified image generation service, and monitor usage and subscription terms to generate accurate billing schedules and other management reports.

### DESCRIPTION OF DRAWINGS

FIG. 1 illustrates an overall cloud system architecture In which various embodiments of the present teachings can be practiced;

FIG. 2 illustrates an overall cloud system architecture including multiple cloud arrangements in which various embodiments of the present teachings can be practiced in another regard, according to various embodiments;

FIG. 3 illustrates a network configuration in which a cloud management system can perform various image-management and cross-cloud deployment functions, according to various embodiments;

FIG. 4 illustrates an exemplary hardware configuration for a cloud management system, according to various embodiments; and

FIG. 5 illustrates a flowchart for overall cross-cloud deployment and management processing in a cloud computing environment, according to various embodiments.

### DESCRIPTION OF EMBODIMENTS

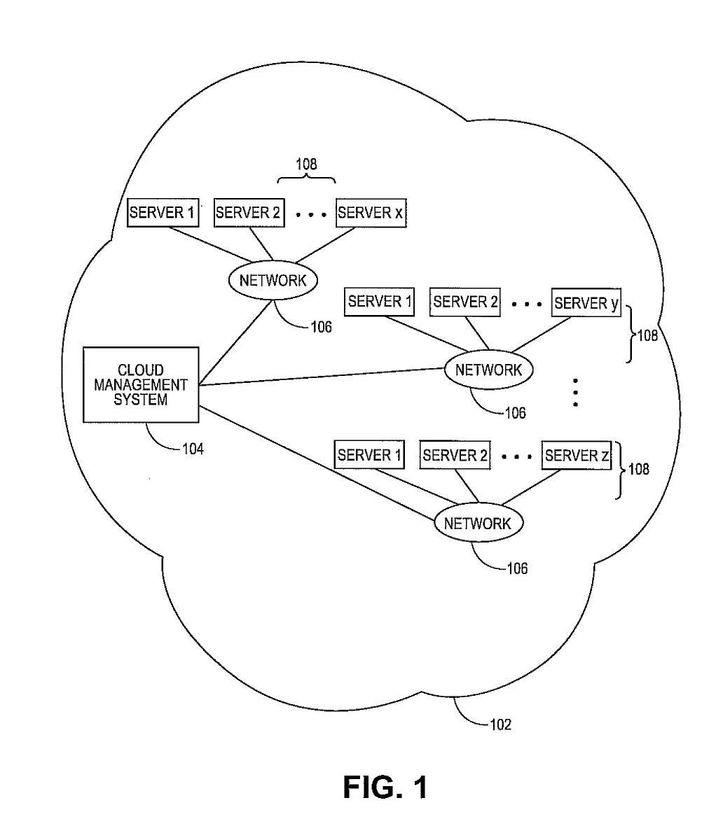

Embodiments relate to systems and methods for a usage manager for cross-cloud appliances. More particularly, embodiments relate to platforms and techniques in which an image generation service can receive and register a set of images of computing appliances and/or other software, objects, or entities, and build cloud-specific sets of images of those appliances for population across diverse host clouds. The subscription model including price, usage, and other license terms for each vendor can be adapted to the various host clouds, and user histories can be captured to generate billing details and other management reports. Other image management functions can be performed via the image generation service or engine. Embodiments described herein can be implemented in or supported by a cloud network architecture. As used herein, a “cloud” can comprise a collection of resources that can be invoked to instantiate a virtual machine, process, or other resource for a limited or defined duration. As shown for example in FIG. 1, the collection of resources supporting a cloud 102 can comprise a set of resource servers 108 configured to deliver computing components needed to instantiate a virtual machine, process, or other resource. For example, one group of resource servers can host and serve an operating system or components thereof to deliver to and instantiate a virtual machine. Another group of resource servers can accept requests to host computing cycles or processor time, to supply a defined level of processing power for a virtual machine. A further group of resource servers can host and serve applications to load on an instantiation of a virtual machine, such as an email client, a browser application, a messaging application, or other applications or software. Other types of resource servers are possible.

In embodiments, the entire set of resource servers 108 or other hardware or software resources used to support the cloud 102 along with its instantiated virtual machines is managed by a cloud management system 104. The cloud management system 104 can comprise a dedicated or centralized server and/or other software, hardware, and network tools that communicate via network 106 such as the Internet or other public or private network with all sets of resource servers to manage the cloud 102 and its operation. To instantiate a new set of virtual machines, a user can transmit an instantiation request to the cloud management system 104 for the particular type of virtual machine they wish to invoke for their intended application. A user can for instance make a request to instantiate a set of virtual machines configured for email, messaging or other applications from the cloud 102. The request can be received and processed by the cloud management system 104, which identifies the type of virtual machine, process, or other resource being requested. The cloud management system 104 can then identify the collection of resources necessary to instantiate that machine or resource. In embodiments, the set of instantiated virtual machines or other resources can for example comprise virtual transaction servers used to support Web storefronts, or other transaction sites.

In embodiments, the user's instantiation request can specify a variety of parameters defining the operation of the set of virtual machines to be invoked. The instantiation request, for example, can specify a defined period of time for which the instantiated machine or process is needed. The period of time can be, for example, an hour, a day, or other increment of time. In embodiments, the user's instantiation request can specify the instantiation of a set of virtual machines or processes on a task basis, rather than for a predetermined amount of time. For instance, a user could request resources until a software update is completed. The user's instantiation request can specify other parameters that define the configuration and operation of the set of virtual machines or other instantiated resources. For example, the request can specify an amount of processing power or input/output (I/O) throughput the user wishes to be available to each instance of the virtual machine or other resource. In embodiments, the requesting user can for instance specify a service level agreement (SLA) acceptable for their application. Other parameters and settings can be used. One skilled in the art will realize that the user's request can likewise include combinations of the foregoing exemplary parameters, and others.

When the request to instantiate a set of virtual machines or other resources has been received and the necessary resources to build that machine or resource have been identified, the cloud management system 104 can communicate with one or more set of resource servers 108 to locate resources to supply the required components. The cloud management system 104 can select providers from the diverse set of resource servers 108 to assemble the various components needed to build the requested set of virtual machines or other resources. It may be noted that in some embodiments, permanent storage such as hard disk arrays may not be included or located within the set of resource servers 108 available to the cloud management system 104, since the set of instantiated virtual machines or other resources may be intended to operate on a purely transient or temporary basis. In embodiments, other hardware, software or other resources not strictly located or hosted in the cloud can be leveraged as needed. For example, other software services that are provided outside of the cloud 102 and hosted by third parties can be invoked by in-cloud virtual machines. For further example, other non-cloud hardware and/or storage services can be utilized as an extension to the cloud 102, either on an on-demand or subscribed or decided basis.

With the resource requirements identified, the cloud management system 104 can extract and build the set of virtual machines or other resources on a dynamic or on-demand basis. For example, one set of resource servers 108 may respond to an instantiation request for a given quantity of processor cycles with an offer to deliver that computational power immediately and guaranteed for the next hour. A further set of resource servers 108 can offer to immediately supply communication bandwidth, for example on a guaranteed minimum or best-efforts basis. In other embodiments, the set of virtual machines or other resources can be built on a batch basis or at a particular future time. For example, a set of resource servers 108 may respond to a request for instantiation at a programmed time with an offer to deliver the specified quantity of processor cycles within a specific amount of time, such as the next 12 hours.

The cloud management system 104 can select group of servers in the set of resource servers 108 that match or best match the instantiation request for each component needed to build the virtual machine or other resource. The cloud management system 104 can then coordinate the integration of the completed group of servers from the set of resource servers 108, to build and launch the requested set of virtual machines or other resources. The cloud management system 104 can track the combined group of servers selected from the set of resource servers 108, or other distributed resources that are dynamically or temporarily combined, to produce and manage the requested virtual machine population or other resources.

In embodiments, the cloud management system 104 can generate a resource aggregation table that identifies the various sets of resource servers that will be used to supply the components of the virtual machine or process. The sets of resource servers can be identified by unique identifiers such as, for instance, Internet protocol (IP) addresses or other addresses. The cloud management system 104 can register the finalized group of servers in the set resource servers 108 contributing to an instantiated machine or process.

The cloud management system 104 can then set up and launch the initiation process for the virtual machines, processes, or other resources to be delivered from the cloud. The cloud management system 104 can for instance transmit an instantiation command or instruction to the registered group of servers in set of resource servers 108. The cloud management system 104 can receive a confirmation message back from each participating server in set of resource servers 108 indicating a status regarding the provisioning of their respective resources. Various sets of resource servers may confirm, for example, the availability of a dedicated amount of processor cycles, amounts of electronic memory, communications bandwidth, or applications or other software prepared to be served.

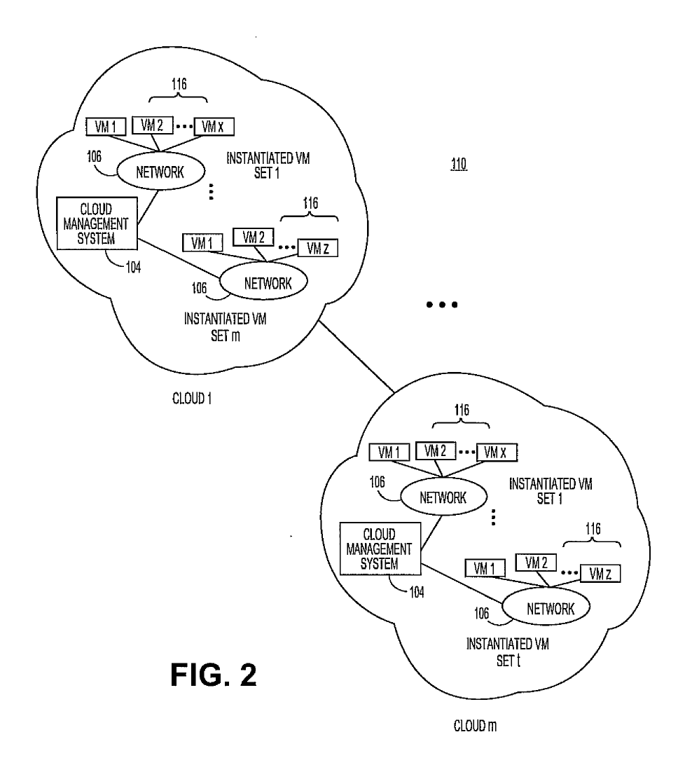

As shown for example in FIG. 2, the cloud management system 104 can then instantiate one or more than one set of virtual machines 116, or other processes based on the resources supplied by the registered set of resource servers 108. In embodiments, the cloud management system 104 can instantiate a given number, for example, 10, 500, 1000, or other numbers of virtual machines to be made available to users on a network 114, such as the Internet or other public or private network. Each virtual machine can be assigned an instantiated machine ID that can be stored in the resource aggregation table, or other record or image of the instantiated population. Additionally, the cloud management system 104 can store the duration of each virtual machine and the collection of resources utilized by the complete set of instantiated virtual machines 116.

In embodiments, the cloud management system 104 can further store, track and manage a user's identity and associated set of rights or entitlements to software, hardware, and other resources. Each user that populates a set of virtual machines in the cloud can have specific rights and resources assigned and made available to them. The cloud management system 104 can track and configure specific actions that a user can perform, such as provision a set of virtual machines with software applications or other resources, configure a set of virtual machines to desired specifications, submit jobs to the set of virtual machines or other host, manage other users of the set of instantiated virtual machines 116 or other resources, and other privileges or actions. The cloud management system 104 can further generate records of the usage of instantiated virtual machines to permit tracking, billing, and auditing of the services consumed by the user. In embodiments, the cloud management system 104 can for example meter the usage and/or duration of the set of instantiated virtual machines 116, to generate subscription billing records for a user that has launched those machines. Other billing or value arrangements are possible.

The cloud management system 104 can configure each virtual machine to be made available to users of the network 114 via a browser interface, or other interface or mechanism. Each instantiated virtual machine can communicate with the cloud management system 104 and the underlying registered set of resource servers 108 via a standard Web application programming interface (API), or via other calls or interfaces. The set of instantiated virtual machines 116 can likewise communicate with each other, as well as other sites, servers, locations, and resources available via the Internet or other public or private networks, whether within a given cloud 102 or between clouds.

It may be noted that while a browser interface or other front-end can be used to view and operate the set of instantiated virtual machines 116 from a client or terminal, the processing, memory, communications, storage, and other hardware as well as software resources required to be combined to build the virtual machines or other resources are all hosted remotely in the cloud 102. In embodiments, the set of virtual machines 116 or other resources may not depend on or require the user's own on-premise hardware or other resources. In embodiments, a user can therefore request and instantiate a set of virtual machines or other resources on a purely off-premise basis, for instance to build and launch a virtual storefront or other application.

Because the cloud management system 104 in one regard specifies, builds, operates and manages the set of instantiated virtual machines 116 on a logical level, the user can request and receive different sets of virtual machines and other resources on a real-time or near real-time basis, without a need to specify or install any particular hardware. The user's set of instantiated machines 116, processes, or other resources can be scaled up or down immediately or virtually immediately on an on-demand basis, if desired. In embodiments, the various sets of resource servers that are accessed by the cloud management system 104 to support a set of instantiated virtual machines 116 or processes can change or be substituted, over time. The type and operating characteristics of the set of instantiated virtual machines 116 can nevertheless remain constant or virtually constant, since instances are assembled from abstracted resources that can be selected and maintained from diverse sources based on uniform specifications.

In terms of network management of the set of virtual machines 116 that have been successfully configured and instantiated, the cloud management system 104 can perform various network management tasks including security, maintenance, and metering for billing or subscription purposes. The cloud management system 104 of a given cloud can 102, for example, install or terminate applications or appliances on individual machines. The cloud management system 104 can monitor operating virtual machines to detect any virus or other rogue process on individual machines, and for instance terminate the infected application or virtual machine. The cloud management system 104 can likewise manage an entire set of instantiated clients 116 or other resources on a collective basis, for instance, to push or delivery a software upgrade to all active virtual machines. Other management processes are possible.

In embodiments, more than one set of virtual machines can be instantiated in a given cloud at the same, overlapping or successive times. The cloud management system 104 can, in such implementations, build, launch and manage multiple sets of virtual machines based on the same or different underlying set of resource servers 108, with populations of different instantiated virtual machines 116 such as may be requested by different users. The cloud management system 104 can institute and enforce security protocols in a cloud 102 hosting multiple sets of virtual machines. Each of the individual sets of virtual machines can be hosted in a respective partition or sub-cloud of the resources of the main cloud 102. The cloud management system 104 of a cloud can for example deploy services specific to isolated or defined sub-clouds, or isolate individual workloads/processes within the cloud to a specific sub-cloud. The subdivision of the cloud 102 into distinct transient sub-clouds or other sub-components which have assured security and isolation features can assist in establishing a multiple user or multi-tenant cloud arrangement. In a multiple user scenario, each of the multiple users can use the cloud platform as a common utility while retaining the assurance that their information is secure from other users of the overall cloud system. In further embodiments, sub-clouds can nevertheless be configured to share resources, if desired.

In embodiments, and as also shown in FIG. 2, the set of instantiated virtual machines 116 generated in a first cloud 102 can also interact with a set of instantiated virtual machines or processes generated in a second, third or further cloud 102. The cloud management system 104 of a first cloud 102 can interface with the cloud management system 104 of a second cloud 102, to coordinate those domains and operate the clouds and/or virtual machines or processes on a combined basis. The cloud management system 104 of a given cloud 102 can track and manage individual virtual machines or other resources instantiated in that cloud, as well as the set of instantiated virtual machines or other resources in other clouds.

In the foregoing and other embodiments, the user making an instantiation request or otherwise accessing or utilizing the cloud network can be a person, customer, subscriber, administrator, corporation, organization, or other entity. In embodiments, the user can be or include another virtual machine, application or process. In further embodiments, multiple users or entities can share the use of a set of virtual machines or other resources.

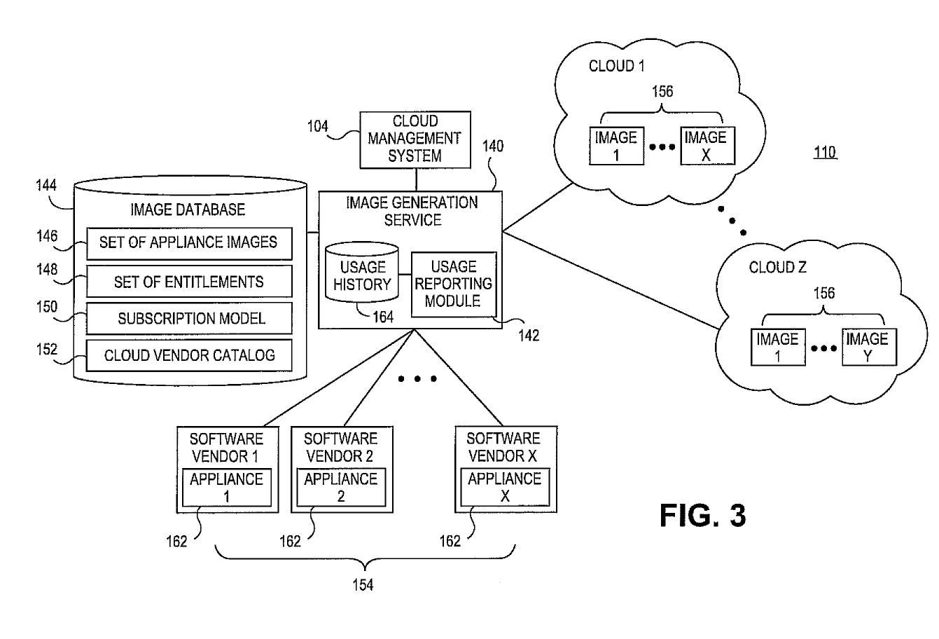

FIG. 3 illustrates an illustrative network in which systems and methods for a usage manager for cross-cloud appliances can be implemented, according to aspects of the present teachings. In embodiments as shown, a set of vendors 154 can build, host, and develop a set of appliances 162. In aspects, set of vendors 154 can include independent software vendors (ISVs), developers, individuals, and other entities. In aspects, set of appliances 162 can comprise a set of hardware, software, virtual, and/or other computing appliances, which can be configured as special-purpose and/or pre-configured machines loaded with particular software applications for specific purposes. In aspects, a vendor in set of vendors 152 can develop one or more than one appliance.

In embodiments, set of vendors 154 can communicate with an image generation service 140 to provide a set of appliance images 146 representing or encoding set of appliances 162 for cloud deployment purposes. More particularly, in embodiments as shown, set of vendors 154 can transmit constituent code, attributes, and/or complete versions of set of appliances 162 to image generation service 140, to generate set of appliance images 146 and related data. In aspects, image generation service 140 can register set of appliance images 146 to appliance database 144. image generation service 140 can also receive and register a desired subscription model 150 for each vendor and/or appliance supported and managed by image generation service 140, reflecting a set of entitlements 148 for end-users, along with other data. For instance, set of entitlements 148 for an appliance can indicate that Appliance A will be available on a one-month subscription basis for 100 images or users in cloud X or cloud Y of cloud environment 110, during which time unlimited technical support will be made available to the end-users. Other provisioning, usage, and/or other terms or conditions can be specified in subscription model 150, set of entitlements 148, and other related data.

In aspects, image generation service 140 can operate on set of appliance images 146 to generate, test, validate and instantiate set of cloud-based images 156 for installation to one or more clouds of cloud environment 110. In aspects, each cloud of cloud environment 110 can contain, host, or access different classes, types, and/or amounts of resources to support appliances and other virtual machines in their respective domains. In aspects, set of cloud-based images 156 of the underlying appliance(s) can therefore comprise individual images conforming to the available resources of different clouds, such as memory, bandwidth, processing power, security, and/or other resources. In conjunction with the tailoring of images in set of cloud-based images 156 to individual clouds, image generation service 140 can likewise map or adjust the subscription model 150 supplied by individual vendors to account for varying resource and billing constraints or factors of various clouds in cloud environment 110. In aspects as shown, image generation service 140 can comprises a usage reporting module 142 that contains logic, communication, and other resources to track the usage of set of cloud-based images 156 once those images are generated, instantiated, and placed into service in one or more clouds by end users. In aspects, usage reporting module 142 can maintain and/or access a usage history database 164 recording the usage of cloud-based images 156 and other usage data. As part of image generation, registration, tracking and/or other activities, image generation service 140 and/or usage reporting module 142 can communicate with one or more cloud management system 104 supporting one or more clouds of cloud environment 110.

In aspects, image generation service 140 can generate a cloud vendor catalog 152 from the aggregate set of cloud-based images 156 and related software, data, or resources to indicate the complete set of virtual computing appliances and/or other resources populated in cloud environment 110. In aspects, an end-user or other user who wishes to view the available appliances and/or other resources in cloud environment 110 can search and view could vendor catalog, and key on vendor IDs, appliance IDs, cloud IDs, and/or other keys or reports. It may be noted that in embodiments, image generation service 140 can receive updated versions of set of appliance images 146, and generate corresponding updated set of cloud-based images 156 for updated deployment to cloud environment 110.

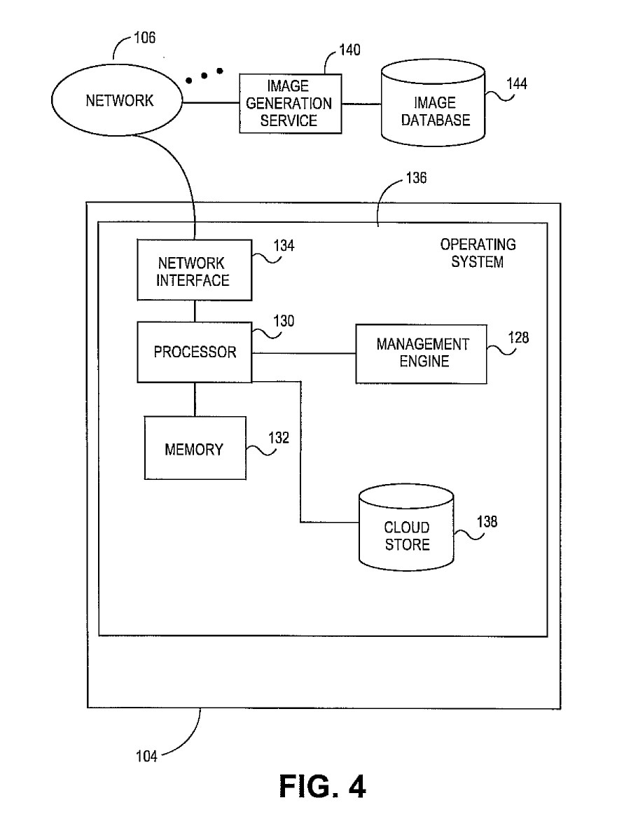

FIG. 4 illustrates an exemplary diagram of hardware and other resources that can be incorporated in a cloud management system 104 configured to communicate with set of instantiated virtual machines 116 via one or more networks 106, according to embodiments. In embodiments as shown, cloud management system 104 can comprise a processor 130 communicating with memory 132, such as electronic random access memory, operating under control of or in conjunction with operating system 136. Operating system 136 can be, for example, a distribution of the Linux™ operating system, the Unix operating system, or other open-source or proprietary operating system or platform. Processor 130 also communicates with cloud store 138, such as a database stored on a local hard drive. Processor 130 further communicates with network interface 134, such as an Ethernet or wireless data connection, which in turn communicates with one or more networks 106, such as the Internet or other public or private networks, via which processor 130 can communicate with image generation service 140, image database 144, and/or other resources. Processor 130 also communicates with management engine 128, to execute control logic and control the operation of virtual machines and other resources in cloud 102. Other configurations of cloud management system 104, associated network connections, and other hardware and software resources are possible.

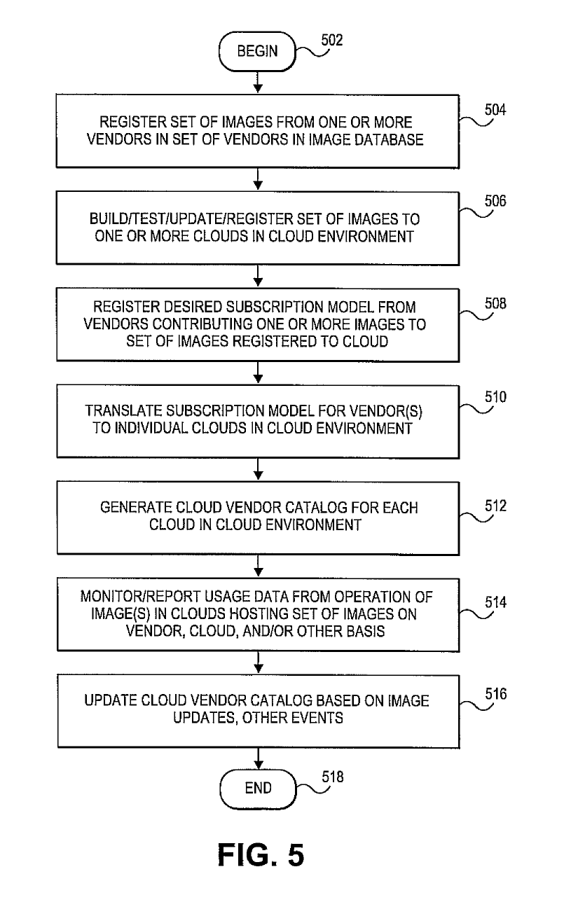

FIG. 5 illustrates a flowchart of overall cross-cloud appliance image deployment and management processing, according to various embodiments of the present teachings. In 502, processing can begin. In 504, a set of appliance images 146 of a set of appliances 162 provided, generated, and/or supplied by vendors in a a set of vendors 154 can be received and registered in image database 144. In embodiments, image database 144 can be a local or remote data store maintained and/or accessed by image generation service 140. In embodiments, image generation service 140 can be or include a Web site and/or other network portal, location, or channel. In 506, the image generation service 140 can build, test, update, and/or register a set of cloud-based images 156 of the underlying appliances or other objects to be instantiated in one or more host clouds in cloud environment 110. In aspects, set of cloud-based images 156 can be registered to one or more host clouds in cloud environment 110 via cloud management system 104.

In 508, image generation service 140 can receive and/or register the desired subscription model 150 from vendors contributing one or more images in set of cloud-based images 156 that are registered to a cloud or clouds in cloud environment 110. In aspects, the subscription model 150 can be or include license terms such as the identity of an appliance and/or its constituent software, rights to update or upgrade that software, purchase price, subscription price on a daily, monthly or other basis, and/or other set of entitlements 148, terms, and/or conditions for usage of the subject appliance(s) in cloud environment 110. In 510, image generation service 140 can translate or adjust the subscription model 150 for each vendor to individual clouds in cloud environment 110, including to map to services or resources supplied by individual clouds. Terms that may pertain to or include constraints or limitations of a cloud can include, for instance, a number of images or instances of an appliance available in a cloud versus unlimited images, peak usage subscription charges, and/or other service, support, and/or billing terms that may differ between cloud providers. In 512, image generation service 140 can generate a cloud vendor catalog 152 for each cloud in cloud environment 110 to which a set of cloud-based images 156 of underlying appliances and/or other software or objects have been populated. In 514, image generation service 140 can monitor cloud environment 110 including set of cloud-based images 156 deployed in one or more clouds therein to report usage data from operation of set of cloud-based images 156 in those host clouds. In aspects, usage data can be aggregated on different bases, including on a per-cloud basis, a per-vendor basis, a per-end user basis, and/or can be combined using other logic or rules. In aspects, the usage data can be collected by a usage reporting module 142 hosted in or accessed by image generation service 140, and can include billing details or reports. In 516, image generation service 140 can update cloud vendor catalog 152 based on updates to set of appliance images 146, set of cloud-based images 156, and/or other events or conditions. In 518, as understood by persons skilled in the art, processing can repeat, return to a prior processing point, jump to a further processing point, or end.

The foregoing description is illustrative, and variations in configuration and implementation may occur to persons skilled in the art. For example, while embodiments have been described in which the cloud management system 104 for a particular cloud resides in a single server or platform, in embodiments the cloud management system and 104 associated logic can be distributed among multiple servers or systems. Similarly, while embodiments have been described in which one group of servers within a set of resource servers 108 can provide one component to build a requested set of virtual machines, in embodiments, one group of resource servers can deliver multiple components to populate the requested set of virtual machines 116. Other resources described as singular or integrated can in embodiments be plural or distributed, and resources described as multiple or distributed can in embodiments be combined. The scope of the invention is accordingly intended to be limited only by the following claims.

1. A method of generating a usage management record in a cloud environment, comprising:
registering a set of appliance images to an image database;
receiving a subscription model for each appliance image from a set of vendors providing the set of appliance images;
generating a set of cloud-based images based on the set of appliance images and a set of resource profiles for a set of cloud-based networks;
instantiating the set of cloud-based images in the set of cloud-based networks based on the subscription model; and
tracking and storing usage history data for the set of cloud-based images in the set of cloud-based network in a usage database.

2. The method of claim 1, wherein each cloud-based network comprises a set of resource servers configured to deliver resources to instantiate the set of cloud-based images.

3. The method of claim 1, further comprising adapting the subscription model for each appliance image to at least one corresponding cloud in the set of cloud-based networks.

4. The method of claim 3, further comprising generating a set of billing data for use of the set of cloud-based images based on the usage history data and corresponding subscription model.

5. The method of claim 1, wherein the set of billing data comprises billing data generated on at least one of a per-appliance basis, a per-user basis, a per-vendor basis, or a per-cloud basis.

6. The method of claim 1, wherein the subscription model comprises at least one of licensing information or a set of entitlements to usage of the set of cloud-based images.

7. The method of claim 6, wherein the subscription model comprises a set of entitlements, and the set of entitlements comprises comprises at least one of a maximum number of cloud-based images in the set of cloud-based images, a maximum number of users of the set of cloud-based images, a maximum run time for the set of cloud-based images, or a set of support services related to the set of cloud-based images.

8. The method of claim 1, further comprising aggregating the set of cloud-based images for at least one cloud in the set of cloud-based networks to generate a vendor cloud catalog.

9. The method of claim 1, wherein the set of appliance images comprises at least one of an image of a physical machine or an image of a virtual machine.

10. The method of claim 9, wherein the set of appliance images comprises at least one of a set of installed operating system software or a set of application software.

11. A system for generating a usage management record for appliances in a cloud environment, comprising:
a network interface to a set of cloud-based networks; and
a processor, communicating with the set of cloud-based networks to execute the image generation service, the processor being configured to—
register a set of appliance images to an image database,
receive a subscription model for each appliance image from a set of vendors providing the set of appliance images,
generate a set of cloud-based images based on the set of appliance images and a set of resource profiles for a set of cloud-based networks,
instantiate the set of cloud-based images in the set of cloud- based networks based on the subscription model, and
track and store usage history data for the set of cloud-based images in the set of cloud-based network in a usage database.

12. The system of claim 11, wherein each cloud-based network comprises a set of resource servers configured to deliver resources to instantiate the set of cloud-based images.

13. The system of claim 11, wherein the processor is further configured to adapt the subscription model for each appliance image to at least one corresponding cloud in the set of cloud-based networks.

14. The system of claim 13, herein the processor is further configured to generate a set of billing data for use of the set of cloud-based images based on the usage data and corresponding subscription model.

15. The system of claim 11, wherein the set of billing data comprises billing data generated on at least one of a per-appliance basis, a per-user basis, a per-vendor basis, or a per-cloud basis.

16. The system of claim 11, wherein the subscription model comprises at least one of licensing information or a set of entitlements to usage of the set of cloud-based images.

17. The system of claim 16, wherein the subscription model comprises a set of entitlements, and the set of entitlements comprises comprises at least one of a maximum number of cloud-based images in the set of cloud-based images, a maximum number of users of the set of cloud-based images, a maximum run time for the set of cloud-based images, or a set of support services related to the set of cloud-based images.

18. The system of claim 11, wherein the processor is further configured to aggregate the set of cloud-based images for at least one cloud in the set of cloud-based networks to generate a vendor cloud catalog.

19. The system of claim 11, wherein the set of appliance images comprises at least one of an image of a physical machine or an image of a virtual machine.

20. The system of claim 19, wherein the set of appliance images comprises at least one of a set of installed operating system software or a set of application software.
